(19) United States
(12) Patent Application Publication
(10) Pub. No.: US 2025/0058377 A1
(43) Pub. Date: Feb. 20, 2025

(54) POWDER PRESS AND METHOD OF FORMING ELECTROCHEMICAL CELL STACK INTERCONNECTS BY POWDER PRESSING

(71) Applicant: Bloom Energy Corporation, San Jose, CA (US)

(72) Inventor: Harald HERCHEN, Los Altos, CA (US)

(21) Appl. No.: 18/798,089

(22) Filed: Aug. 8, 2024

Related U.S. Application Data
(60) Provisional application No. 63/532,804, filed on Aug. 15, 2023.

(51) Int. Cl. B22F 3/03; B22F 3/16; C25B 13/02; C25B 13/05; H01M 8/0208; H01M 8/0258; H01M 8/12; H01M 8/2483

(52) U.S. Cl. CPC B22F 3/03; B22F 3/16; C25B 13/02; C25B 13/05; H01M 8/0208; H01M 8/0258; H01M 8/2483; B22F 2203/00; B22F 2301/20; B22F 2301/35; H01M 2008/1293

(57) ABSTRACT

A powder pressing method includes laterally moving a dispensing plate and a base plate disposed under the dispensing plate from a pressing position to a dispensing position, laterally moving the base plate back to the pressing position while the dispensing plate remains in the dispensing position, such that a powder is released from apertures in the dispensing plate into a die cavity, laterally moving the dispensing plate back to the pressing position, and pressing the powder in the die cavity to form an article.

### FIELD

The present disclosure is directed to an apparatus and method for manufacturing electrochemical cell stack components, specifically to a powder press apparatus and a powder processing method for making interconnects for electrochemical cell stacks.

### BACKGROUND

A typical solid oxide fuel cell stack includes multiple fuel cells separated by metallic interconnects (ICs) which provide both electrical connection between adjacent cells in the stack and channels for delivery and removal of fuel and oxidant. The metallic interconnects are commonly composed of a Cr-based alloys such as CrFe and CrFeY alloys. The CrFe and CrFeY alloys retain their strength and are dimensionally stable at typical solid oxide fuel cell (SOFC) operating conditions, e.g., 700-900° C. in both air and wet fuel atmospheres. However, depending on the topographical design of ICs, conventional powder press methods can suffer from lower than desired product yields due to higher than desired porosity in the interconnects.

### SUMMARY

In one embodiment, a powder press comprises a die comprising a die cavity; a lower punch; an upper punch; a base plate disposed over the die at least in a dispensing position; a dispensing plate disposed over the base plate and comprising apertures; and a fill shoe disposed over the dispensing plate at least in a fill position and configured to dispense a powder into the apertures, wherein the base plate and the dispensing plate are configured to independently move laterally between a pressing position in which the base plate and the dispensing plate are disposed below the fill shoe and laterally displaced from the die cavity, and the dispensing position in which the base plate and the dispensing plate are disposed over the die cavity.

In another embodiment, a powder pressing method includes laterally moving a dispensing plate and a base plate disposed under the dispensing plate from a pressing position to a dispensing position, laterally moving the base plate back to the pressing position while the dispensing plate remains in the dispensing position, such that a powder is released from apertures in the dispensing plate into a die cavity, laterally moving the dispensing plate back to the pressing position, and pressing the powder in the die cavity to form an article.

### BRIEF DESCRIPTION OF THE DRAWINGS

FIG. 1A is a sectional view of a portion of an electrochemical cell stack including electrochemical cells and interconnects, according to various embodiments of the present disclosure.

FIG. 1B schematic side view of an interconnect of FIG. 1A.

FIG. 1C is a top view of the air side of an interconnect of FIG. 1A.

FIG. 1D is a top view of a fuel side of an interconnect of FIG. 1A.

FIG. 2 is a schematic view of a prior art powder press.

FIG. 3A is a schematic view of a powder press according to various embodiments of the present disclosure.

FIGS. 3B-3E are top views of dispensing plates that may be included in the press of FIG. 3A.

FIGS. 4A-4H are schematic views illustrating a method of forming a green interconnect using the press of FIG. 3A, according to various embodiments of the present disclosure.

FIG. 5 is a top view showing regions of a fuel side of an interconnect, according to various embodiments of the present disclosure.

FIG. 6A is a top view of a dispensing plate aperture pattern superimposed on the interconnect of FIG. 5, according to various embodiments of the present disclosure.

FIG. 6B is a top view of a dispensing plate including the aperture pattern of FIG. 6A, according to various embodiments of the present disclosure.

FIG. 6C is a top view of a dispensing plate aperture pattern superimposed on the interconnect of FIG. 5, according to various embodiments of the present disclosure.

FIG. 6D is a top view of a dispensing plate including the aperture pattern of FIG. 6C, according to various embodiments of the present disclosure.

### DETAILED DESCRIPTION

The various embodiments will be described in detail with reference to the accompanying drawings. The drawings are not necessarily to scale and are intended to illustrate various features of the invention. Wherever possible, the same reference numbers will be used throughout the drawings to refer to the same or like parts. References made to particular examples and implementations are for illustrative purposes and are not intended to limit the scope of the invention or the claims.

Ranges can be expressed herein as from “about” one particular value, and/or to “about” another particular value. When such a range is expressed, examples include from the one particular value and/or to and including the other particular value. In some embodiments, a value of “about X” may include values of +/−1% X. It will be further understood that the endpoints of each of the ranges are significant both in relation to the other endpoint, and independently of the other endpoint.

An electrochemical cell may be used to produce electrical energy from chemical energy and chemical energy from electrical energy. A fuel cell is an electrochemical cell that may convert the chemical energy of a fuel (e.g., hydrogen or hydrocarbon fuel) and an oxidizing agent (e.g., air or oxygen) into electricity. An electrolysis cell is an electrochemical cell that may use electricity to drive a chemical reaction (e.g., decomposition of water into hydrogen and oxygen).

The electrochemical cell, such as a fuel cell, may include an anode, a cathode and an electrolyte between the anode and cathode that allows ions (e.g., hydrogen ions, oxygen ions, etc.) to move between the anode and cathode. The electrochemical cell may have substantially planar shape in which case the anode, the cathode and the electrolyte may be formed as layers in the electrochemical cell. This may allow a plurality of the electrochemical cells to be stacked together to form an electrochemical cell stack (e.g., fuel cell stack, electrolysis cell stack, etc.).

The electrochemical cells in the electrochemical cell stack may be separated by interconnects. The interconnects may serve as gas flow separator plates that separate a gas at a first electrode (e.g., anode) of an electrochemical cell from a gas at a second electrode (e.g., cathode) of an adjacent electrochemical cell in the stack.

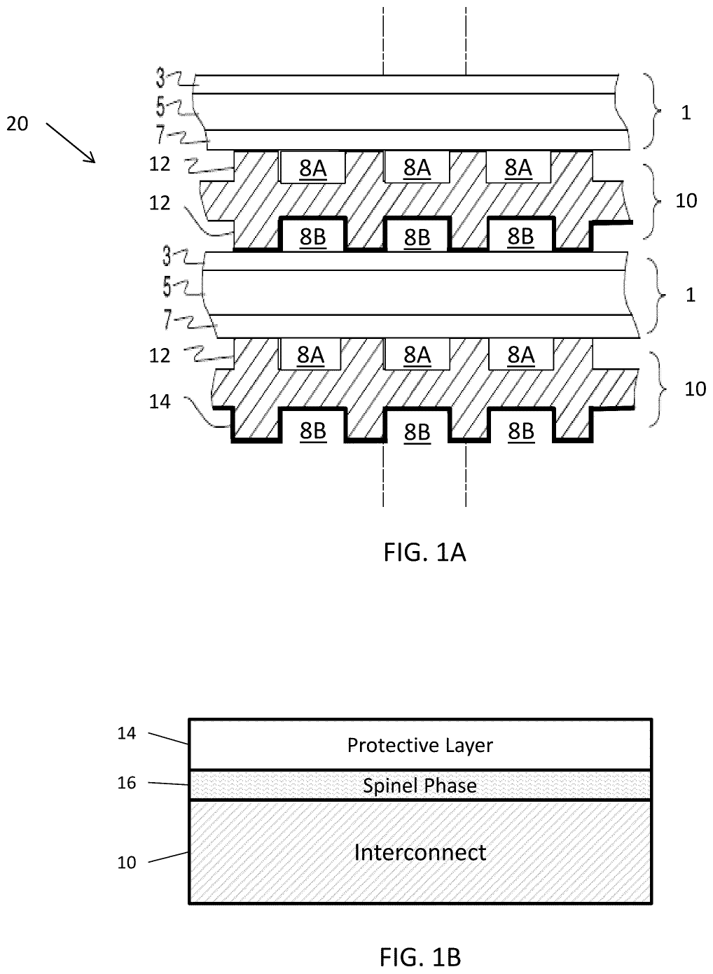

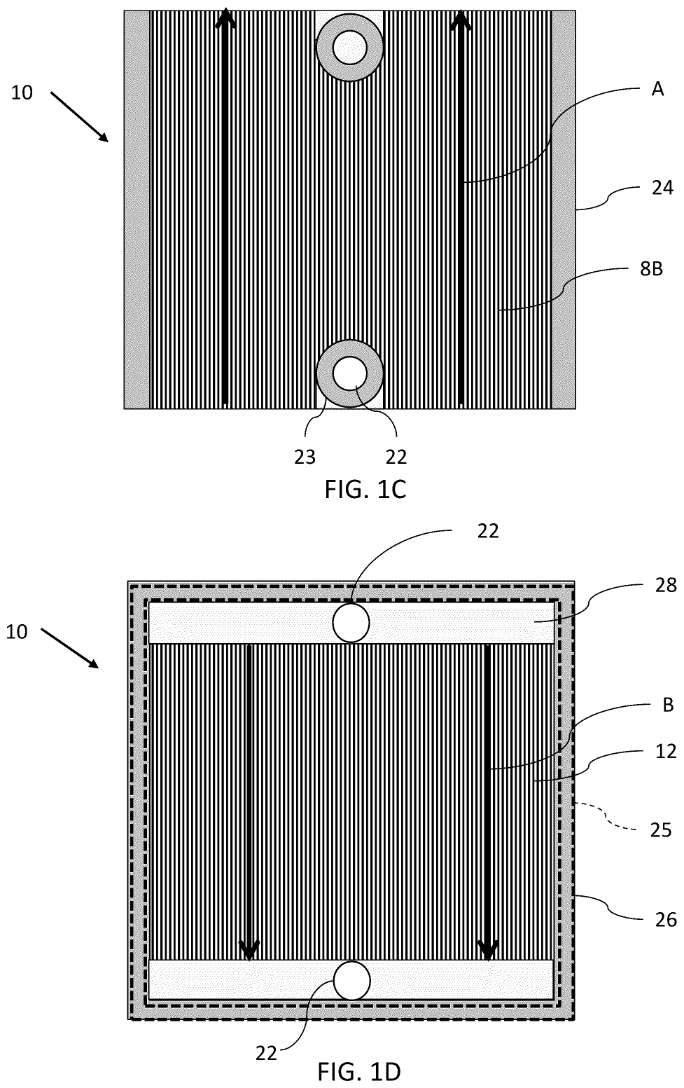

FIG. 1A is a sectional view of a portion of an electrochemical cell stack 20, according to various embodiments of the present disclosure, FIG. 1B is a schematic side view of an interconnect 10 of FIG. 1A, FIG. 1C is a top view of the air side of an interconnect 10 of FIG. 1A, and FIG. 1D is a top view of a fuel side of an interconnect 10 of FIG. 1A. The electrochemical cell stack 20 may comprise a fuel cell stack or an electrolyzer cell stack, such as solid oxide fuel cell (SOFC) stack or a solid oxide electrolyzer cell (SOEC) stack.

Referring to FIGS. 1A-1D, the stack 20 includes multiple electrochemical cells (e.g., fuel cells, such as SOFCs, or electrolyzer cells, such as SOECs) 1 that are separated by interconnects 10, which may also be referred to as gas flow separator plates or bipolar plates. Each electrochemical cell 1 includes an electrolyte 5 and first and second electrodes (7, 3) located on opposite sides of the electrolyte 5.

Each interconnect 10 electrically connects adjacent electrochemical cells 1 in the stack 20. In particular, an interconnect 10 may electrically connect a first electrode 7 of one electrochemical cell 1 to the second electrode 3 of an adjacent electrochemical cell 1. Each interconnect 10 includes ribs 12 that at least partially define channels 8A and 8B.

In a SOEC stack 20, water (e.g., steam) may be provided to a first electrode 7 of the SOEC 1 through interconnect 10 channels 8A and air may optionally be provided to the second electrode 3 of the SOEC 1 through the interconnect 10 channels 8B. The water is separated into hydrogen and oxygen at the first electrode 7, and oxygen ions are transported from the first electrode 7 through the electrolyte 5 to the second electrode 3 when a voltage or current is applied to the electrolyzer stack 20.

In a SOFC stack 20, the interconnect 10 may operate as a gas-fuel separator that separates a fuel, such as a hydrocarbon or hydrogen fuel, flowing to the first electrode 7 (e.g., fuel electrode, which is referred to as an anode) of one SOFC 1 in the stack 20 from an oxidant, such as air, flowing to the second electrode 3 (e.g., air electrode which is referred to as a cathode) of an adjacent SOFC 1 in the stack 20. At either end of the stack 20, there may be an air end plate or fuel end plate (not shown) for providing air or fuel, respectively, to the end electrode. Air flows through the air channels 8B to a cathode electrode 3 of an adjacent fuel cell 1. In particular, the air may flow across the interconnect 10 in a first direction A as indicated by the arrows of FIG. 1C.

Ring seals 23 may surround fuel holes 22 of the interconnect 10, to prevent fuel from contacting the cathode electrode. Peripheral strip-shaped seals 24 are located on peripheral portions of the air side of the interconnect 10. The seals 23, 24 may be formed of a glass or glass-ceramic material. The peripheral portions of the interconnect 10 may be in the form of an elevated plateau which does not include ribs or channels. The surface of the peripheral regions may be coplanar with tops of the ribs 12.

As shown in FIG. 1D, the fuel side of the interconnect 10 may include the fuel channels 8A and fuel manifolds 28 (e.g., fuel plenums). Fuel flows from one of the fuel holes 22, into the adjacent fuel manifold 28, through the fuel channels 8A, and to an anode 7 of an adjacent fuel cell 1. Excess fuel may flow into the other fuel manifold 28 and then into the adjacent fuel hole 22. In particular, the fuel may flow across the interconnect 10 in a second direction B, as indicated by the arrows.

A frame seal 25 may be disposed on a peripheral frame seal region 26 of the fuel side of the interconnect 10. The frame seal region 26 may be an elevated plateau which does not include ribs or channels. The surface of the frame seal region 26 may be coplanar with tops of the ribs 12. Accordingly, the frame seal region 26 may be thicker in the stack direction than fuel manifold regions 28.

The interconnect 10 shown in FIGS. 1C and 1D is externally manifolded for air and internally manifolded for fuel. The air and fuel flow in counter-flow (i.e., opposite directions) across the air and fuel sides of the interconnect 10. Other interconnect configurations may also be used. In alternative embodiments, co-flow or crossflow interconnect configurations may be used, such as for example, a crossflow interconnect described in U.S. Patent Application Publication Number 2019/0372132 A1, incorporated herein by reference in its entirety. Furthermore, the interconnects may be internally manifolded for air and/or externally manifolded for fuel.

Interconnects are typically made from a Cr-based alloys such as CrFe alloys, which have a composition of 93-97 wt. % Cr and 3-7 wt. % Fe (e.g., 95 wt. % Cr and 5 wt. % Fe) or CrFeY alloys having a 94 wt. % Cr, 5 wt. % Fe and 1 wt. % Y composition. As used herein, an “alloy” may be formed by mixing metal elements in the liquid state or by pressing and sintering two different elemental metal powders (such as elemental Cr and elemental Fe powders) using powder metallurgy processing. The CrFe and CrFeY alloys retain their strength and are dimensionally stable at typical solid oxide fuel cell (SOFC) operating conditions, e.g., 700-900° C. in both air and wet fuel atmospheres.

In some embodiments, the air-side surface of the interconnects 10 may be coated with a protective coating 14 (see FIG. 1A), in order to decrease the growth rate of chromium oxide on the air-side surface of the interconnects 10 and to suppress evaporation of chromium vapor species which can poison the air-side electrodes 3 (e.g., fuel cell cathodes 3) in the stack 20. However, in some embodiments the protective coating 14 may be formed on both the air side and the fuel side of the interconnects 10. The protective coating 14 may be formed using a spray coating process, such as plasma spraying, or a dip coating process.

Typically, the protective coating 14 may comprise a perovskite material such as lanthanum strontium manganite (LSM). Alternatively, metal oxide spinel materials, such as a (Mn, Co)₃O₄ spinel materials, can be used instead of or in addition to LSM. Any spinel having the composition Mn₂₋ₓCo₁₊ₓO₄ (0≤x≤1) or written as z (Mn₃O₄)+(1−z)(CO₃O₄), where (⅓≤z≤⅔) or written as (Mn, Co)₃O₄ may be used. Operation of the stack 20 may result in the formation of a chromium-transition metal oxide spinel layer 16 between the interconnect 10 and the protective coating 14 on the air side of the interconnects 10 in the stack 20, as shown in FIG. 1B.

According to various embodiments, interconnects 10 may be formed by powder metallurgy, which includes pressing an interconnect powder in a hydraulic or mechanical press to produce a “green part” part having a desired interconnect shape. The interconnect powder may include a metal or metal alloy powder, such as a Cr-based Cr—Fe or Cr—Fe—Y alloy as described above or from a heterogeneous mixture of elemental Cr powder and elemental Fe powder (which may also include Y powder). If a heterogeneous powder mixture is used during the powder metallurgy pressing, then it may include 93-97 wt. % Cr powder particles and 3-7 wt. % Fe powder particles (e.g., 95 wt. % Cr and 5 wt. % Fe). The interconnect powder may also include an organic lubricant and/or binder. The green part is subsequently sintered to form the interconnect 10. During sintering, the Cr powder particles and Fe powder particles interdiffuse to form the Cr—Fe alloy of the interconnect 10.

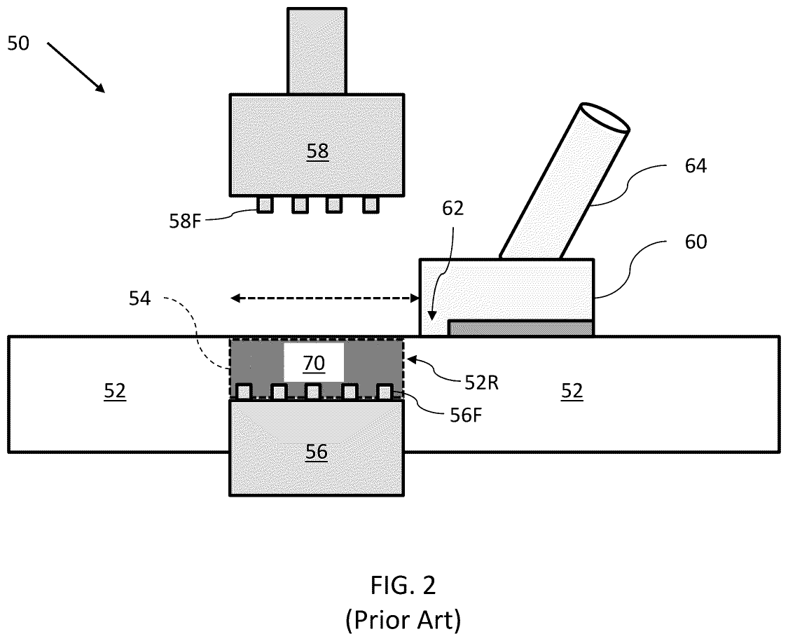

FIG. 2 is a schematic view of a conventional (i.e., prior art) powder press 50. Referring to FIG. 2, the press 50 may include a die 52 having a die cavity 54, a lower punch 56 disposed below the die cavity 54, and an upper punch 58 disposed above the die cavity 54. The press 50 may also include a fill shoe 60 having an opening (e.g., a slit shaped dispensing port) 62 and a hopper 64 configured to provide powder 70 to the fill shoe 60. The fill shoe 60 moves laterally over the die cavity 54 while dispensing the powder, in order to fill the die cavity 54 with an amount of powder 70. The amount of powder directly above any particular location above the features 56F of the lower punch 56 (such as the protrusions in the lower punch which correspond to the fuel channels 8A and fuel manifold regions 28 in the interconnect 10, for example) is lower than directly above any particular location between the features 56F of the lower punch 56. The top surface of the powder 70 after the shoe 60 retracts is nearly co-planar with the top surface of the die 52, or equivalently, bottom of the shoe 60 in the prior art powder press 50. The upper punch 58 also has features 58F (e.g., protrusions which correspond to the air channels 8B in the interconnect 10, for example). The end result is that the local amount of powder 70 above any particular feature 56F when using the prior art powder press 50 is not proportional to the local volume of the pressed part (e.g., interconnect 10) above any particular feature 56F. The thinnest region of the pressed part (e.g., the fuel manifold region 28 of the interconnect 10) may be located next to the thickest region of the pressed part (e.g., the frame seal region 26). With the prior art shoe 50 and its flat powder profile on top, there is more than enough powder at the thinnest region of the pressed part, while there may be an insufficient amount of powder at the thickest region of the pressed part to achieve sufficiently uniform pressed part density upon compaction.

The powder 70 is pressed between the punches 56, 58 to form a green body, such as a green interconnect. A compaction pressure applied to the powder 70 may vary according to the thickness of the delivered powder and the corresponding local thickness of the compacted interconnect. Different regions of a powder metallurgy interconnect may therefore have different densities, depending on the locally delivered powder distribution. For example, if there is excess powder, then a higher compaction pressure may be applied at the thinner regions 28 of the interconnect 10, while a lower compaction pressure may be applied to thicker regions 26 of the interconnect 10 that have locally insufficient powder for that thickness.

As a result, the thicker regions of an interconnect may have a higher porosity than the thinner regions thereof. If the interconnect 10 is made of discrete particles of nominally pure Cr and Fe powder mixture (i.e., a mixture of elemental Cr and Fe powders), this density or porosity variation may lead to coefficient of thermal expansion (CTE) differences and a reduction in surface flatness after the interconnect has been sintered. For example, CTE variations across but within the interconnect may result in warping and/or buckling of the interconnect when there is a temperature change, such as when an interconnect is sintered and then returned to room temperature. Therefore, manufacturing processes utilizing a conventional powder press 50 may produce interconnects that lack uniformity, which may result in reduced production yields, and/or may result in reduced electrical contact with the electrochemical cells in the stack and/or fuel or air leakage through the interconnect when such interconnects are incorporated into a fuel cell stack. An additional problem associated with conventional methods is that air exiting a die cavity during powder filling may fluidize the powder, which results in undesirable powder filling non-uniformities.

The prior art powder press 50 also includes a controller (not shown) which is programmed to slightly, but meaningfully, raise the lower punch 56 just as the opening (i.e., slit shaped dispensing port) 62 in the shoe 60 is nearly fully retracted, starting at a distance of about 10 to 30 mm from the opening 62 to the trailing edge of the die cavity 54 at the right hand side wall 52R of the die 52 in FIG. 2. The purpose of raising the lower punch 56 is to compensate for powder compression that happens when the shoe 60 is pulled back (i.e., retracted). Pulling the shoe 60 back has friction associated with it which shears the powder 70. The shear force compresses the powder 70 in the die cavity 54. Compression makes the powder 70 denser, which means that less powder 70 volume is needed near the trailing edge 52R of the of the die cavity 54, and the lower punch 56 is raised to compensate for this effect. This raising of the lower punch 56 while the shoe 60 retracts complicates the method of operating the prior art powder press 50.

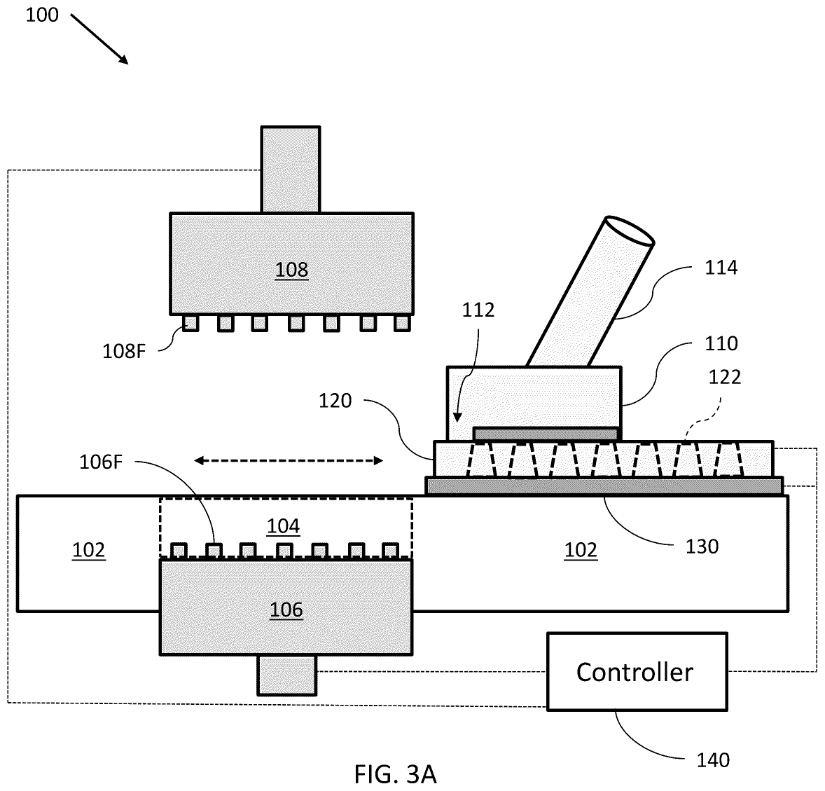

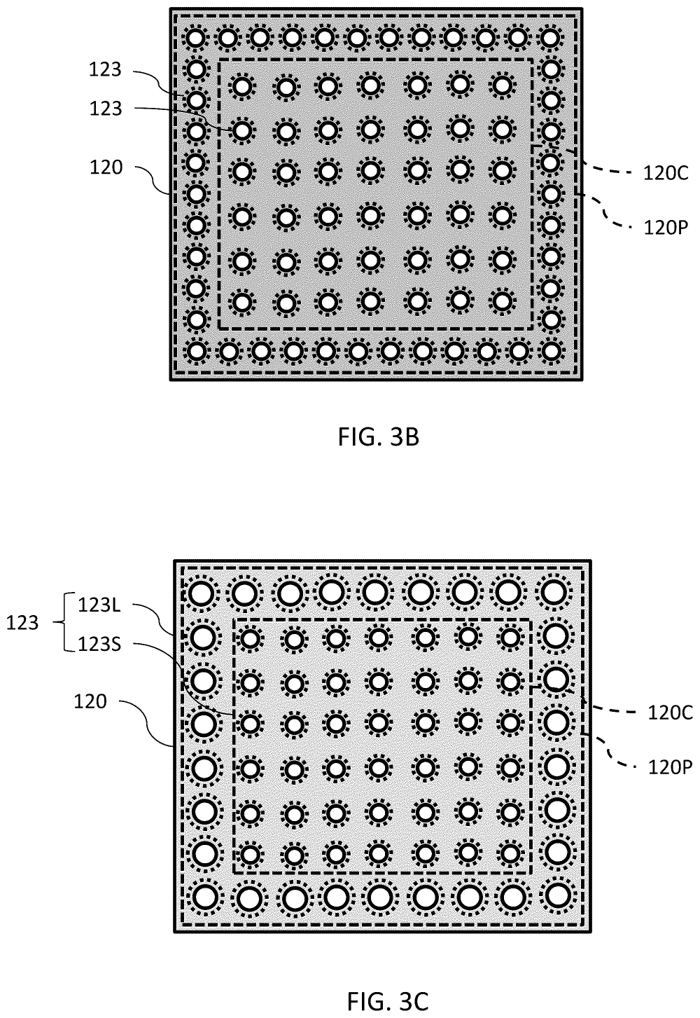

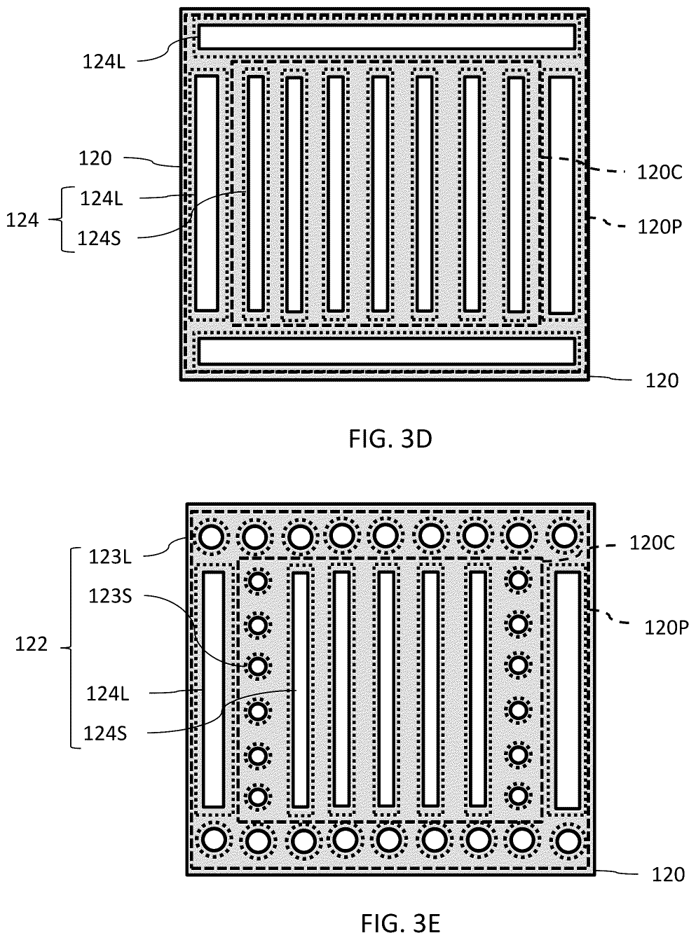

FIG. 3A is a schematic view of a powder press 100, according to various embodiments of the present disclosure. FIGS. 3B-3E are top views of different dispensing plates 120 that may be used in the press 100 of FIG. 3A. Referring to FIG. 3A, the press 100 may include a die 102 having a die cavity 104, a lower punch 106 disposed below the die cavity 104, and an upper punch 108 disposed above the die cavity 104. Opposing surfaces of the punches 106, 108 include features 106F, 108F, such as recesses and protrusions, etc. to form corresponding structures (e.g., ribs 12A, 12B and channels 8A, 8B) of a green body, such as a green interconnect, from pressed powder in the die cavity. In one embodiment, the upper and lower punches 106, 108 have pressing surface features 106F, 108F that are inverse of at least ribs 12A, 12B and channels 8A, 8B formed on opposite sides of the interconnect 10 for the electrochemical stack 20.

The press 100 may also include a fill shoe 110 having a dispensing port 112 and a hopper 114 configured to provide a powder, such as a metal interconnect powder to the fill shoe 110. In some embodiments, the fill shoe 110 may be fixed in position above the die 102 near the die cavity 104. In other embodiments, the fill shoe 110 may be movable laterally relative to the top surface of the die 102.

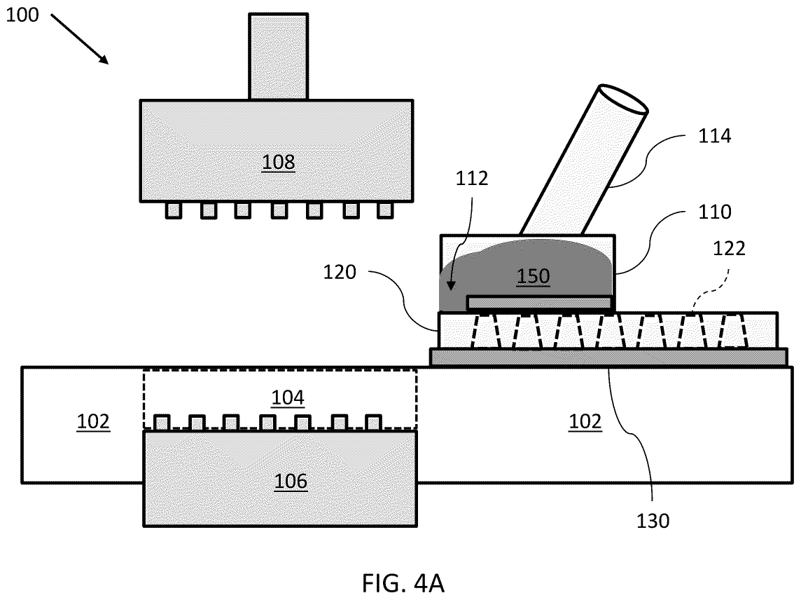

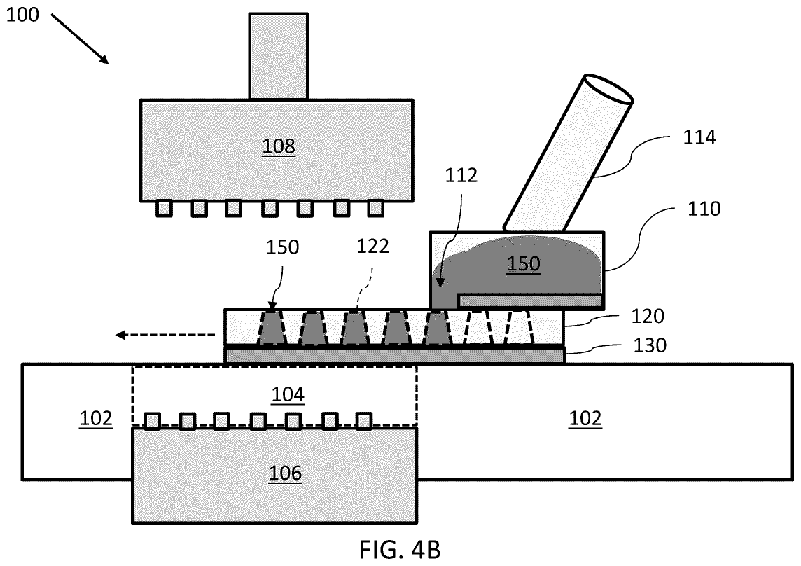

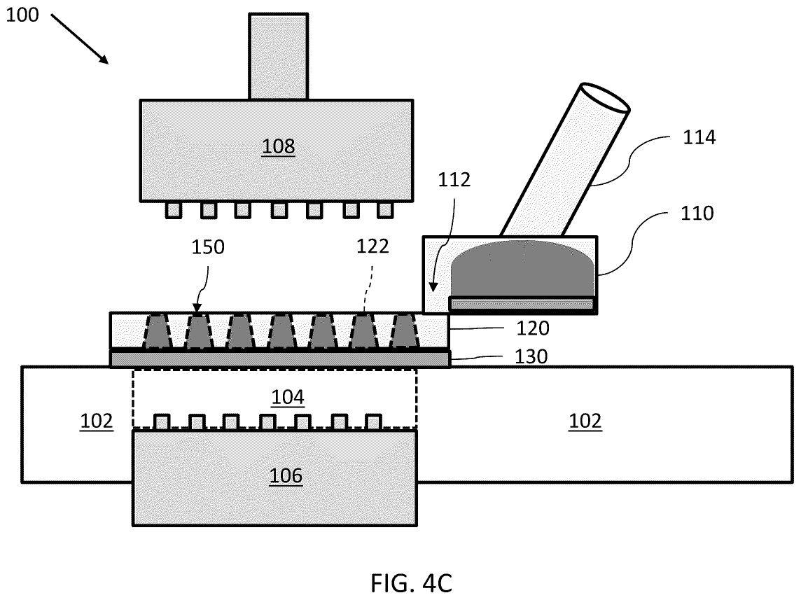

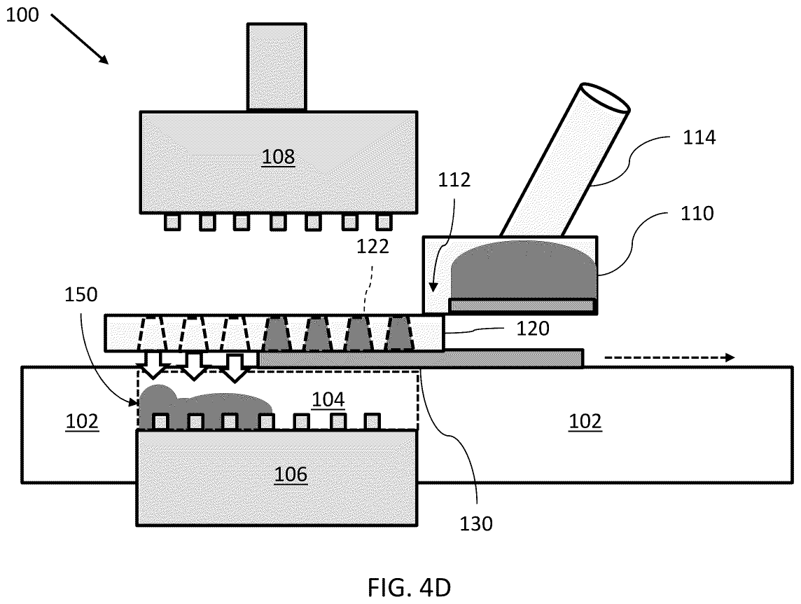

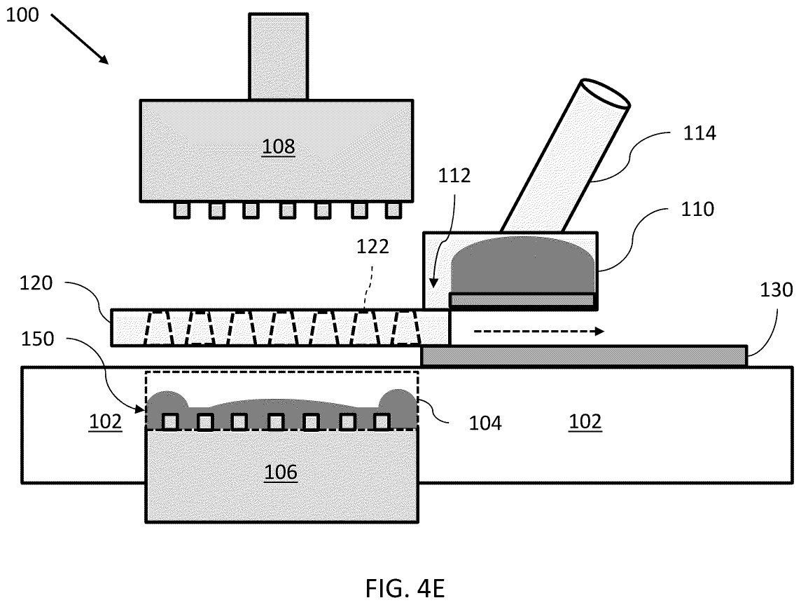

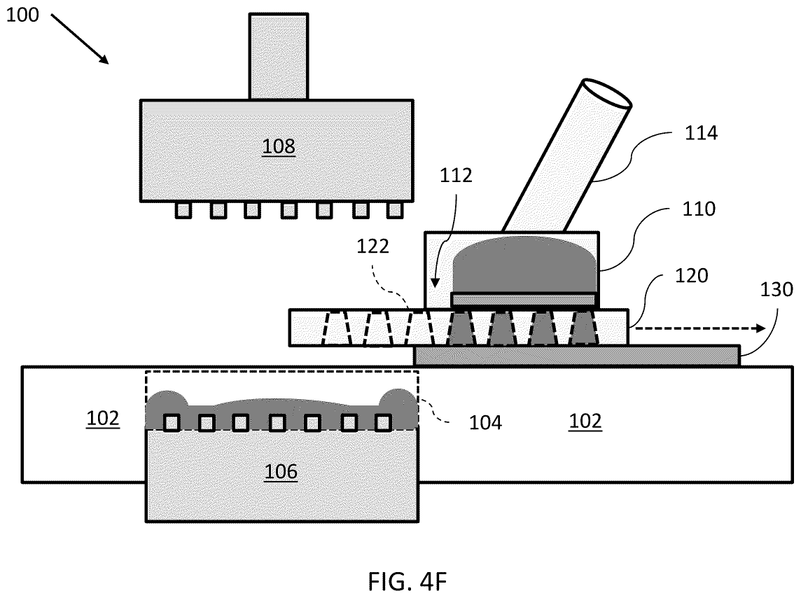

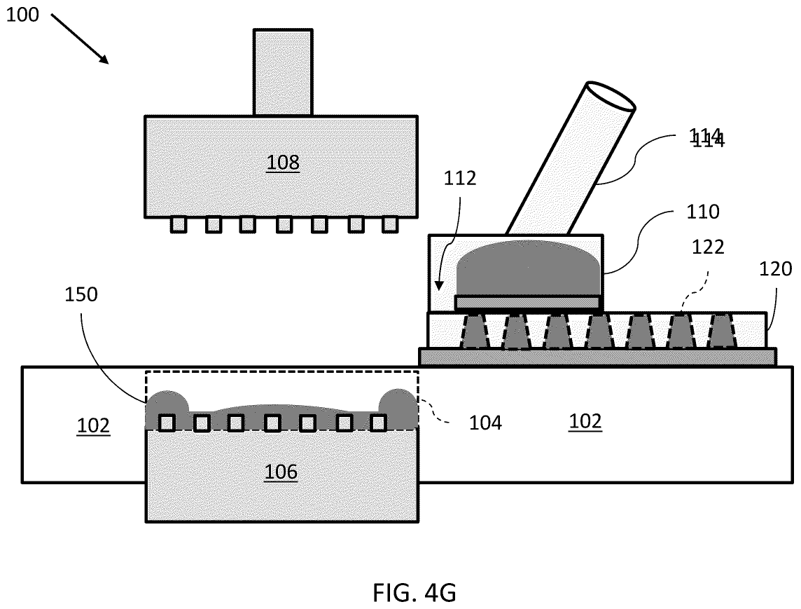

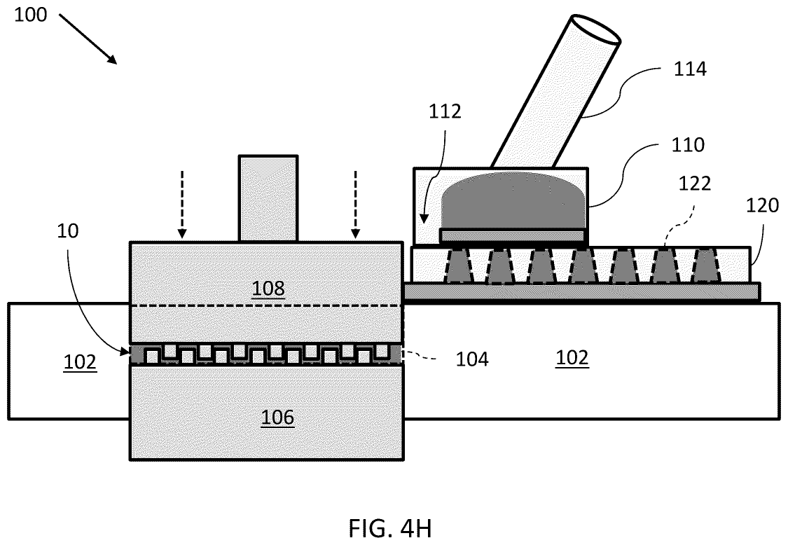

The press 100 may also include a dispensing plate 120 and a base plate 130. The dispensing plate 120 may include apertures 122 (e.g., through holes and/or slots). The dispensing plate 120 is movable laterally relative to the fill shoe 110 such that it can be disposed over the die cavity 104 and above the base plate 130. The plates 120, 130 may be configured to move independently from each other and independently from the fill shoe 110 in a lateral direction, as shown by the dashed arrow of FIG. 3A. In particular, the plates 120, 130 may move laterally between a pressing position as shown in FIG. 3A, where the plates 120, 130 are disposed below the fill shoe 110 away from the die cavity 104, and a dispensing position where the plates 120, 130 are disposed above the die cavity 104, as discussed in detail below with respect to FIGS. 4A-4H. The fill shoe 110 may be configured to dispense powder into the apertures 122 via the dispensing port 112, as the dispensing plate 120 moves laterally relative to the dispensing port 112. In an alternative embodiment, the fill shoe 110 may move laterally relative to the dispensing plate 120 to dispense the powder into the apertures 122 via the dispensing port 112. In another alternative embodiment, both the fill shoe 110 and the dispensing plate 120 may move laterally relative to each other to dispense the powder into the apertures 122 via the dispensing port 112.

The press 100 may further include a controller 140 configured to control various elements of the press 100. The controller 140 may control movement of the plates 120, 130 and/or the punches 106 and/or 108 by controlling actuators and/or motors thereof. The controller 140 may include a central processing unit, microcontroller, etc., and a memory device (not shown) configured to store instructions and other data (e.g., history data, reference data, performance data, etc.). The memory device may be included in the controller 140 or remotely (e.g., outside the press 100). The controller 140 may be configured to execute the instructions stored in the memory device. In one embodiment, the controller 140 may comprise a general purpose or a special purpose computer which is in wired and/or wireless communication with the elements of the press 100. The controller 140 is configured to independently laterally move the base plate 130 and the dispensing plate 120 between the pressing position and the dispensing position, as will be described in more detail below with regard to FIGS. 4A-4H.

In various embodiments, the apertures 122 may extend from a top surface to a bottom surface of the dispensing plate 120. In some embodiments, the apertures 122 may be tapered, such that the apertures 122 have smaller upper openings on the top surface of the dispensing plate 120 and larger lower openings on the bottom of the dispensing plate 120. The tapering of the apertures 122 may facilitate release of the powder from the bottom openings of the apertures 122 into the die cavity 104 to prevent the powder from getting stuck in the apertures. Furthermore, the space between the apertures 122 permits air to more easily flow out of the die cavity 104 as the powder is being dispensed and reduces the likelihood that the powder becomes fluidized.

In various embodiments, the shape, volume, pattern, and/or density of the apertures 122 may be controlled to achieve a desired powder distribution and/or depth in the die cavity 104. In one embodiment, the apertures 122 may include hole-type apertures 123 (see, e.g., FIG. 3B) and/or slot-type apertures 124 (see, e.g., FIG. 3D).

The hole-type apertures 123 can be generally conical, pyramidal, or prismatic through holes. However, the apertures 123 are not limited to any particular shape. As shown in the embodiment of FIG. 3B, the dispensing plate 120 may be divided into a central region 120C and a peripheral region 120P which surrounds the central region 120C. The central region 120C and the peripheral region 120P may have different aperture 123 densities. For example, the dispensing plate 120 may have a relatively high aperture density in the peripheral region 120P and a relatively low aperture density in the central region 120C. However, the dispensing plate 120 may include any suitable density pattern.

In one embodiment of the present disclosure, the controller 140 does not need to raise the lower punch 106 to compensate for shear induced powder 150 compression caused by shoe retraction, as in the prior art press 50 illustrated in FIG. 2 and described above. Each aperture 122 in the dispensing plate 120 comprises only a fraction of the interconnect 10 length (e.g., 1/29 or 1/58 for 29 and 58 apertures per row configuration) in the direction of the dispensing plate 120 motion. Walls (i.e., solid parts of the dispensing plate 120) separate the apertures 122 from each other. The apertures 122 interrupt the shear induced compression of the powder 150 and make it nearly equal for every aperture. The effects of the shear induced compression are significantly reduced by splitting the shear into many parts (e.g., 29 to 58 parts for 29 to 58 apertures per row in the dispensing plate), and the adjustment (i.e., raising) of the lower punch 106 height is not needed in press 100. Thus, in one embodiment, the lower punch 106 of the press 100 is not raised into the die cavity 140 between the step of laterally moving the dispensing plate 120 and the base plate 130 from the pressing position to the dispensing position and the step of pressing the powder 150 in the die cavity 104 to form an article (e.g., the interconnect 10). This provides an advantage over the prior art press 50 of FIG. 2, because raising the lower punch 56 of the prior art press 50 affects all the powder 70 across the pressed part (perpendicular to the shoe 60 motion), and also has a negative effect of the front part of the prior art shoe 60, just in front of its slot 62.

In some embodiments, the volumes (i.e., sizes) of the hole-type apertures 123 of the dispensing plate 120 may be varied to provide a desired powder distribution. For example, in the embodiment shown in FIG. 3C, the dispensing plate 120 may include large apertures 123L and small apertures 123S. For example, a volume of the large apertures 123L may be at least 5%, at least 10%, at least 15%, or at least 20% larger, such as 5% to 50% larger, than a volume of the small apertures 123S. In some embodiments, the large apertures 123L may be disposed in the peripheral region 120P and the small apertures 123S may be disposed in the central region 120C. However, the dispensing plate 120 may include apertures 123 of more than two different sizes/volumes, which may be arranged in any suitable arrangements.

In another embodiment, which is combination of the embodiments of FIGS. 3B and 3C, the dispensing plate 120 may have a relatively high density of larger apertures 123L in the peripheral region 120P and a relatively low small aperture 123S density in the central region 120C.

In other embodiments, the shape of the apertures 123 may be different. For example, the apertures 123L in the peripheral regions 120P may have an oval horizontal cross-sectional shape, while at least some of the apertures 123S in the central region 120C may have a circular cross-sectional shape.

In the embodiment shown in FIG. 3D, the dispensing plate 120 may include elongated apertures 124 (e.g., slots or channels). The elongated apertures 124 may be prismatic in shape and may have smaller upper openings on the top surface of the dispensing plate 120 and larger lower openings on the bottom of the dispensing plate 120. The elongated apertures 124 may extend lengthwise in any direction. For example, the elongated apertures 124 may extend in parallel and/or perpendicular directions. In one embodiment, the elongated apertures 124 extend in a direction perpendicular to the lateral movement direction of the dispensing plate 120 to reduce the effects of the shear induced compression. The lengths and/or widths of the elongated apertures 124 may be the same or different. In some embodiments, elongated apertures 124 may have different volumes (i.e., sizes). For example, the dispensing plate 120 may include larger volume (e.g., wider) elongated apertures 124L in the peripheral region 120P of the dispensing plate 120 and smaller volume (e.g., narrower) elongated apertures 124S in the central region 120C of the dispensing plate 120.

In the embodiment shown in FIG. 3E, the apertures 122 in the dispensing plate 120 may include both the hole-type shaped apertures 123 and the elongated slot-type apertures 124. The apertures 123 may comprise a combination of large and small through hole-type apertures 123L, 123S. The elongated apertures 124 may comprise a combination of large and small elongated apertures 124L, 124S. The apertures 122 may be disposed in any suitable arrangement for providing a desired powder distribution (e.g., a desired powder depth profile). For example, the large apertures 123L, 124L may be disposed in the peripheral region 120C and the small apertures 123S, 124S may be disposed in the central region 120C. In one embodiment, all of the elongated apertures 124 extend in a direction perpendicular to the lateral movement direction of the dispensing plate 120.

In general, the larger and/or more densely spaced apertures may be provided in areas corresponding to thicker interconnect 10 portions, such as the frame seal region 126, while the smaller and/or less densely spaced apertures may be provided in areas corresponding to thinner interconnect 10 portions, such as the plenums 28. This results in more powder provided to the thicker than thinner interconnect 10 portions.

FIGS. 4A-4H are schematic views illustrating a method of forming a green interconnect using the press 100 of FIG. 3A, according to various embodiments of the present disclosure. Referring to FIG. 4A, the upper punch 108 may be disposed in a raised position and the plates 120, 130 may be disposed below the fill shoe 110 away from the die cavity 104 in a pressing position. In particular, the base plate 130 may be disposed below the dispensing plate 120, such that bottom openings of the apertures 122 are covered by the base plate 130, when both plates 120, 130 are in the pressing position. The apertures 122 may be empty as shown in FIG. 4A. However, in other embodiments, the apertures 122 may be completely or partially filled with an interconnect powder 150. Whether the apertures 122 are filled with the powder 150 or not depends on whether it is the first powder 150 dispensing step since cleaning of the press 100 (in which the apertures 122 are not filled with the powder 150, as shown in FIG. 4A), or a second or subsequent dispensing step since the cleaning of the press 100 (in which case the apertures 122 are filled with the powder 150).

Referring to FIG. 4B, the method may include moving the plates 120, 130 laterally towards the die cavity 104 along a first lateral (i.e., horizontal) direction. As the dispensing plate 120 moves past the dispensing port 112, the apertures 122 may be filled with the interconnect powder 150 dispensed from the fill shoe 110. The interconnect powder 150 may include Cr, Fe, and optionally Y and/or one or more optional transition metals, such as Co, Mn, V, Ni, and/or Cu. In one embodiment, the interconnect powder 150 may include a mixture of elemental Cr and Fe powders, and optionally a Co, Mn, V, Ni, and/or Cu elemental transition metal powder. In another embodiment, the interconnect powder 150 may include a pre-alloyed Cr—Fe powder. In another embodiment, the interconnect powder 150 may include a mixture of elemental Cr powder and pre-alloyed Cr—Fe powder. In yet another embodiment, the interconnect powder 150 may include a mixture of pre-alloyed transition metal-Fe powder and a Cr elemental powder. In yet another alternative embodiment, the interconnect powder 150 may include a mixture of a pre-alloyed transition metal-Cr powder and a Fe elemental powder. In some embodiments, the interconnect powder 150 may also include an organic lubricant and/or binder.

Referring to FIG. 4C, the lateral movement of the plates 120, 130 may be stopped when the plates 120, 130 reach a loading position. In particular, the filled apertures 122 are disposed over the die cavity 104 and the bottom openings of the apertures 122 are covered by the base plate 130, when the plates 120, 130 are both disposed in the loading position.

Referring to FIGS. 4D and 4E, the base plate 130 may be laterally moved back to the pressing position in a second lateral direction opposite to the first lateral direction, while the dispensing plate 120 remains in the loading position. The movement of the base plate 130 allows the powder 150 to fall out of the exposed apertures 122 and into the die cavity 104. The arrangement and/or sizes of the apertures 122 results in a non-uniform loading of the powder 150 in the die cavity 104.

In one embodiment, the deposited powder 150 may be thicker in a peripheral region of the die cavity 104 than in a central region of the die cavity 104. The peripheral region of the die cavity 104 may correspond to the thicker peripheral frame seal region 26 of the interconnect 10. The central region of the die cavity 104 may correspond to the thinner fuel manifold regions 28 of the interconnect 10.

In another embodiment, the powder 150 may be thicker in the peripheral region of the die cavity 104 than in an intermediate region of the die cavity 104 and in the central region of the die cavity 104. The powder 150 may be thicker in the central region of the die cavity 104 than in an intermediate region of the die cavity 104. The peripheral region of the die cavity 104 may correspond to the thicker peripheral frame seal region 26 of the interconnect 10. The intermediate region of the die cavity 104 may correspond to the thinner fuel manifold regions 28 of the interconnect 10 located inward of the peripheral frame seal region 26. The central region of the die cavity 104 may correspond to the flow field region of the interconnect 10 containing the ribs (12A, 12B) and the channels (8A, 8B). Thus, a flow field region of the interconnect 10 containing the ribs separated by the channels is formed in the central region of the die cavity 104, the peripheral frame seal region 26 of the interconnect 10 is formed in the peripheral region of the die cavity 104, and the manifold regions 28 of the interconnect 10 are formed in the intermediate region of the die cavity 104. As described above, the manifold regions 28 of the interconnect 10 are thinner than the peripheral frame seal region 26 of the interconnect 10.

In one embodiment, the powder thickness in the peripheral region of the die cavity 104 may be from about 50 μm to about 2 mm, such as from about 75 μm to about 1.6 mm, or at least about 50 μm greater than a powder thickness in other regions (e.g., central and/or intermediate regions) of the die cavity 104.

Referring to FIGS. 4F and 4G, the dispensing plate 120 may be returned to the pressing position by laterally moving in the second direction to be retracted into a space between the fill shoe 110 and the base plate 130. In some embodiments, the apertures 122 may be optionally filled or partially filled with the powder 150 as the dispensing plate 120 passes below the dispensing port 112 of the fill shoe 110 in the second direction.

Referring to FIG. 4H, the upper punch 108 is lowered into the die cavity 104 to press the powder 150 to form a green interconnect 10 having substantially the same size and shape as a finished interconnect (i.e., “near net shape”). The pressing may include any suitable type of powder compaction process, such as hot isostatic pressing or cold isostatic pressing. The upper punch 108 may then be raised and the green interconnect 10 may be removed for further processing.

For example, the green interconnect 10 may be removed from the press 100, loaded into a furnace, and heated at a temperature ranging from about 200° C. to about 800° C. in a debindering heating step to remove organic components such as lubricants and/or binders included in the powder. The interconnect may then be sintered at a higher temperature, such as a temperature ranging from about 1350° C. to about 1600° C., in a reducing atmosphere (e.g., forming gas or H₂ atmosphere), to promote metal interdiffusion. In some embodiments, the interconnect 10 may undergo a separate controlled oxidation treatment, such as by exposing the interconnect to an oxidizing ambient, such as air, at a high temperature. The oxidation may operate to reduce the porosity of the interconnect.

A surface oxide may be removed from the interconnect 10 by grit blasting or other methods. A protective coating 14 (see FIGS. 1A and 1B) may be formed on at least one side of the interconnect 10. For example, the protective coating may be formed by applying a perovskite and/or spinel material, such as LSM and/or MCO on the sintered interconnect using an air plasma spray (APS) spray process for example. The air plasma spray process is a thermal spray process in which powdered coating materials are fed into the coating apparatus. The coating particles are introduced into a plasma jet in which they are melted and then accelerated toward the interconnect 10. On reaching the interconnect 10, the molten droplets flatten and cool, forming the coating 14. The plasma may be generated by either direct current (DC plasma) or by induction (RF plasma). Further, unlike controlled atmosphere plasma spraying (CAPS) which requires an inert gas or vacuum, air plasma spraying is performed in ambient air.

The method may include assembling multiple interconnects 10 with electrochemical cells 1 and other stack components to form an electrochemical cell stack 20. Operation of the stack 20 may result in the formation of a chromium-transition metal oxide spinel layer 16 between the interconnect 10 and the protective coating 14 on the air side of the interconnects 10 in the stack 20.

While the powder pressing method shown in the embodiments of FIGS. 4A-4H is used to form the interconnect 10, in other embodiments other articles of manufacture may be formed by the powder pressing method. Any suitable metal, cermet or ceramic article of manufacture that can be formed by powder pressing may be formed using the method described above with respect to FIGS. 4A-4H. In some embodiments, the article of manufacture has features (e.g., ribs, protrusions, channels, recesses, etc.) on both sides that face the upper and lower punches 108, 106.

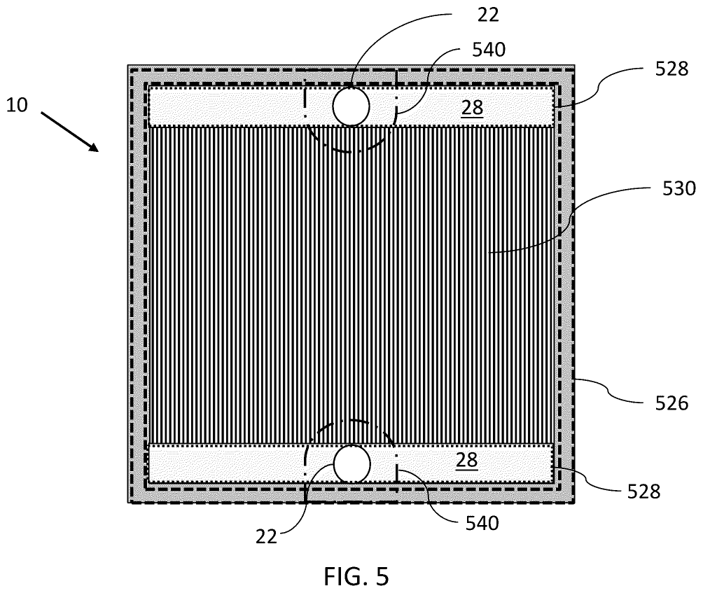

FIG. 5 is a top view of an interconnect 10 of FIG. 1D with different regions. As can be seen in FIG. 5, the interconnect 10 may include fuel holes 22 and may be divided into a peripheral region 526 which includes the peripheral frame seal region 26 on the fuel side, manifold regions 528 which include the fuel manifolds 28 on the fuel side, a central region 530 (e.g., the fuel flow field region located between the manifold regions 528) and fuel hole regions 540 which include upraised pedestals which surround the fuel holes 22 on the air side. The peripheral region 526 may surround the manifold regions 528 and the central region 530. The fuel hole regions 540 may overlap portions of the peripheral region 526, portions of the manifold regions 528 that are adjacent to the fuel holes 22, and portions of the central region 530 that are adjacent to the fuel holes 22. The peripheral region 526 may include some of the thickest portions of the interconnect 10. The manifold regions 528 may include some of the thinnest portions of the interconnect 10. The central region 530 may include intermediate thickness portions of the interconnect 10 due to the alternating ribs and channels. The fuel hole regions 540 may include a high level of thickness variation, due to the structures surrounding the fuel holes 22.

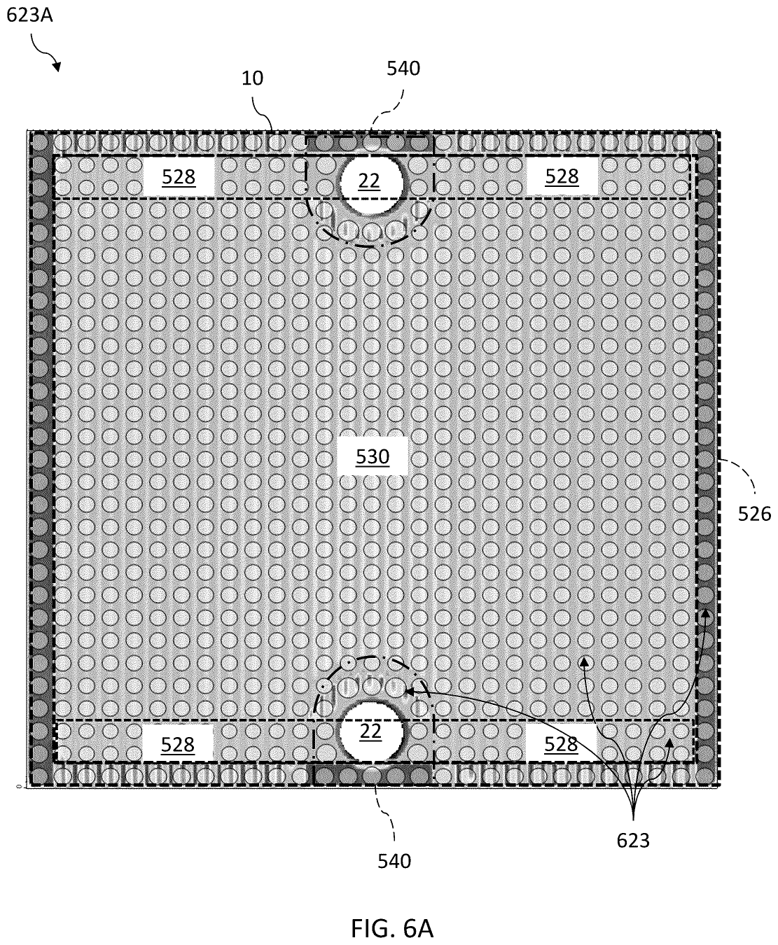

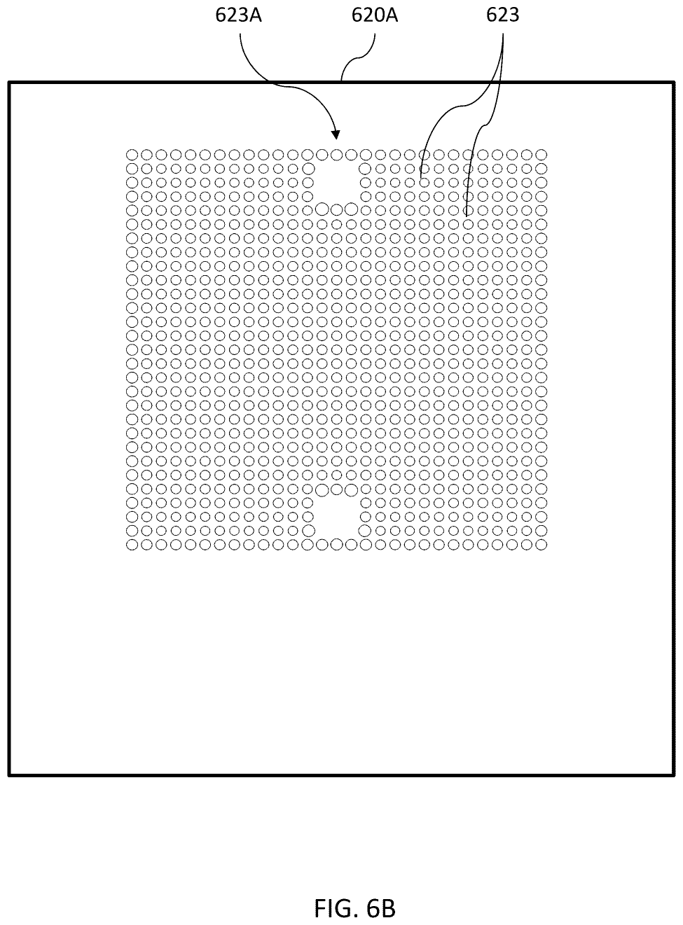

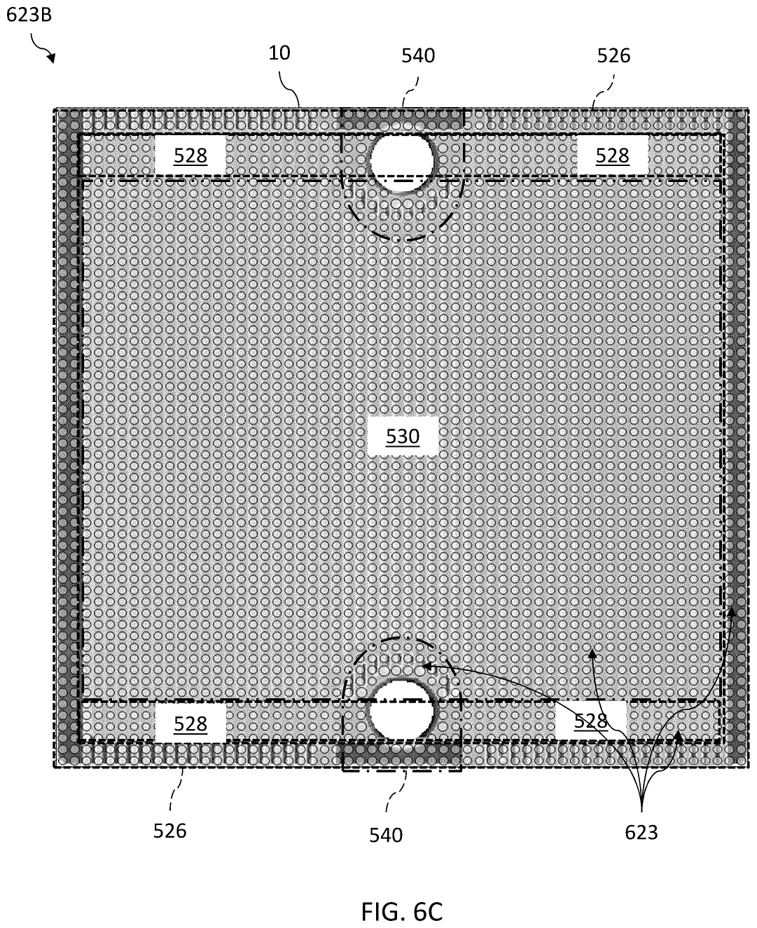

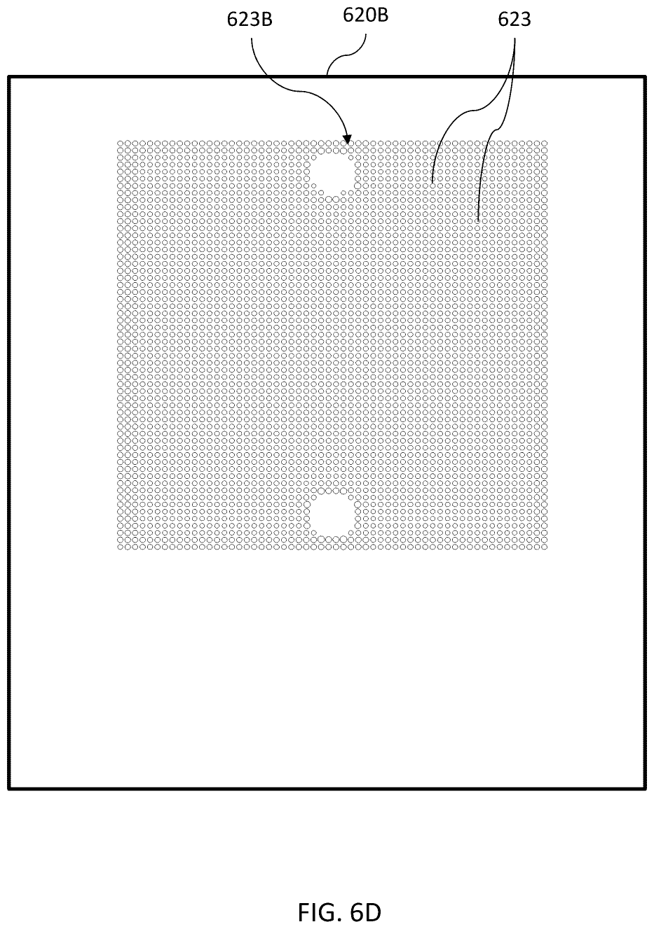

FIGS. 6A and 6C are top views of dispensing plate aperture patterns 623A, 623B of alternative embodiments superimposed on the interconnect 10 of FIG. 5, and FIGS. 6B and 6D are top views of dispensing plates 620A, 620B of the alternative embodiments including the aperture patterns 623A, 623B of FIGS. 6A and 6C, respectively. The dispensing plates 620A, 620B may be used to dispense a metal powder and may be used in place of the dispensing plate 120 described above.

Referring to FIGS. 5, 6A, and 6B, the aperture pattern 623A of the dispensing plate 620A may include columns and rows of dispensing apertures 623. The diameter of the apertures 623 (e.g., the maximum diameters) may vary based on the thickness of portions of the interconnect 10 formed by powder dispensed from corresponding apertures 623, as shown in FIG. 5. In particular, larger apertures 623 may be used to form thicker portions of the interconnect 10, and smaller apertures 623 may be used to form thinner portions of the interconnect 10.

For example, the apertures 623 disposed over the relatively thick peripheral region 526 may have relatively large diameters, in order to increase the density of corresponding thicker portions of the interconnect 10, the apertures 623 disposed over the central region 530 may have intermediate diameters, and the apertures 623 disposed over the relatively thin manifold regions 528 may have relatively small diameters. The apertures 623 disposed over the fuel hole regions 540 may have relatively large, intermediate, and small diameters. In some embodiments, the largest diameter apertures 623 may have a maximum diameter ranging from about 2.8 mm to about 3.6 mm, such as from about 2.9 mm to about 3.5 mm, or about 3.4 mm. The smallest diameter apertures 623 may have a maximum diameter ranging from about 2.2 mm to about 2.6 mm, such as from about 2.4 mm to about 2.5 mm, or about 2.4 mm. For example, for a 110 cm square interconnect 10, the plate 620A may be 5 to 10 mm thick, such as 7 to 8 mm thick. The dispensing pattern 623A may include 25 to 35 apertures 623 per row and column in a square pattern, such as a 29×29 array of apertures 623.

The diameters of the apertures 623 may vary within each of the regions 526, 528, 530 and 540. The darker shades in FIGS. 6A and 6C correspond to the thicker regions of the interconnect. For example, the apertures 623 disposed over darker portions of the peripheral region 526 may have a larger diameter than the remaining apertures 623 disposed over the peripheral region 526. The apertures 623 over the manifold regions 528 may decrease in diameter as the proximity of the apertures 623 to the fuel holes 522 increases.

Referring to FIGS. 5, 6C, and 6D, the dispensing pattern 623B of the dispensing plate 620B may have a higher density than the dispensing pattern 623A of FIGS. 6A and 6B. For example, the four columns and four rows of apertures 623 may be disposed over the peripheral region 526, as compared to the two rows and two columns of the aperture pattern 620A of FIGS. 6A and 6B. As discussed with respect to FIGS. 6A and 6B, the diameters (e.g., maximum diameters) of the apertures 623 of the dispensing pattern 623B may vary based on the thickness of corresponding portions of the interconnect 10 formed by the apertures 623. In some embodiments, the largest diameter apertures 623 may have a maximum diameter ranging from about 1.6 mm to about 2.0 mm, such as from about 1.7 mm to about 1.9 mm, or about 1.8 mm. The smallest diameter apertures 623 may have a maximum diameter ranging from about 0.9 mm to about 1.3 mm, such as from about 1.1 mm to about 1.2 mm, or about 1.13 mm. For example, for a 110 cm square interconnect 10, the plate 620A may be 5 to 10 mm thick, such as 7 to 8 mm thick. The dispensing pattern 623B may include 55 to 60 apertures 623 per row and column in a square pattern, such as a 58×58 array of apertures 623.

According to various embodiments, aperture volume and density may be used to control the mass of a deposited metal powder, based on the thickness of corresponding portions of an interconnect formed from the metal powder. In particular, the mass of the metal powder dispensed from the apertures may be controlled to provide the interconnect with a substantially uniform density. For example, relatively larger diameter apertures may be used to dispense a relatively larger amount of metal powder to form thicker portions of an interconnect, and relatively smaller diameter apertures may be used to dispose a relatively smaller amount of metal powder to form thinner portions of an interconnect. The minimum distance between adjacent apertures 122 is the minimum wall structural thickness that is required between such adjacent apertures 122 in the dispensing plate 120. The maximum distance between adjacent apertures 122 is determined by the ability of the powder to move laterally to fill in the region directly under the wall between adjacent apertures 122. The lateral powder motion occurs under the influence of gravity and is determined by an angle of repose of the powder and any inertial effects during powder dispensing, as well as by the lateral motion as the upper punch 108 starts to push on the powder top after the powder dispensing is complete.

According to various embodiments, the powder press 100 includes a dispensing plate 120/620A/620B and a base plate 130 that allow for the precise loading of the powder 150 into the die cavity 104. In particular, different regions of a die cavity 104 can be loaded with different powder thicknesses. As a result, green body interconnects or other articles which have features (e.g., ribs, protrusions, channels, recesses, etc.) on both sides that face the upper and lower punches can be formed with improved control of feature size and porosity due to the improved control of powder placement in the die cavity 104. For example, the interconnects 10 have a reduced and more uniform porosity. After sintering, the interconnects 10 may have excellent shape and CTE uniformity.

In the prior art method of using the prior art powder press 50 of FIG. 2, the manifold regions 28 are typically the highest density regions of the interconnect 10 because they have the most excess powder 70. When the powder 70 is compacted, most of the compressive force delivered to the punch(es)(56, 58) by the press 50 is therefore predominantly at the two manifold regions 28 of the interconnect 10. Therefore, the prior art press 50 needs a high total force to compact the interconnect 10 because some force is still needed outside the manifold regions 28 to compact the interconnect 10. The increased required total force in the prior art press 50 increases the cost and size of the prior art press 50.

In contrast, in the method of using the embodiment press 100, the total compression force needed is substantially reduced relative to the prior art press 50 because the manifold regions 28 of the interconnect 10 do not necessarily have an extra high density as in the prior art method, and the press 100 force is much more equally distributed. By reducing the total force needed to press the interconnect 10, the embodiment press 100 can be smaller and/or less expensive than the prior art press 50. Alternatively, if the size and/or the total force of the embodiment press 100 is the same as that of the prior art press 50, then the embodiment press 100 may be used to achieve higher interconnect 10 densities, which allows reduction in subsequent interconnect sintering time and oxidation process time, which reduce the interconnect fabrication costs.

Fuel cell systems including the fuel cell stacks 20 of the embodiments of the present disclosure are designed to reduce greenhouse gas emissions as well as emissions such as SOx and NOx and have a positive impact on the climate and pollution reduction.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. A powder press, comprising:
a die comprising a die cavity;
a lower punch;
an upper punch;
a base plate disposed over the die at least in a dispensing position;
a dispensing plate disposed over the base plate and comprising apertures; and
a fill shoe disposed over the dispensing plate at least in a fill position and configured to dispense a powder into the apertures,
wherein the base plate and the dispensing plate are configured to independently move laterally between a pressing position in which the base plate and the dispensing plate are disposed below the fill shoe and laterally displaced from the die cavity, and the dispensing position in which the base plate and the dispensing plate are disposed over the die cavity.

2. The powder press of claim 1, wherein the base plate is configured to block at least some of the lower openings of the apertures when the base plate is disposed below the dispensing plate.

3. The powder press of claim 1, wherein the apertures are configured to drop the powder into the die cavity when the dispensing plate is in the dispensing position and the base plate laterally moves to the pressing position.

4. The powder press of claim 3, wherein:
the apertures are configured such that a thickness of dropped powder in the die cavity varies by at least about 50 μm; and
the upper and lower punches have pressing surface features that are inverse of at least ribs and channels formed on opposite sides of an interconnect for an electrochemical stack.

5. The powder press of claim 1, wherein:
each of the apertures has an upper opening formed on a top surface of the dispensing plate and a lower opening formed on a bottom surface of the dispensing plate; and
the apertures are tapered such that the lower opening of each aperture is larger than its corresponding upper opening.

6. The powder press of claim 1, wherein the apertures comprise large apertures and small apertures, each of the large apertures having a volume that is at least 10% larger than a volume of each of the small apertures.

7. The powder press of claim 1, wherein the apertures disposed in a first region of the dispensing plate have a larger volume than the apertures disposed in a second region of the dispensing plate.

8. The powder press of claim 1, wherein a density of the apertures in a first region of the dispensing plate is higher than a density of the apertures in a second region of the dispensing plate.

9. The powder press of claim 1, wherein the fill shoe is configured to dispense the powder into the apertures as either the dispensing plate moves past a dispensing port of the fill shoe or the dispensing port of the fill show moves past the apertures in the dispensing plate.

10. The powder press of claim 1, further comprising a controller configured to independently, laterally move the base plate and the dispensing plate between the pressing position and the dispensing position.

11. A powder pressing method, comprising:
laterally moving a dispensing plate and a base plate disposed under the dispensing plate from a pressing position to a dispensing position;
laterally moving the base plate back to the pressing position while the dispensing plate remains in the dispensing position, such that a powder is released from apertures in the dispensing plate into a die cavity;
laterally moving the dispensing plate back to the pressing position; and
pressing the powder in the die cavity to form an article.

12. The method of claim 11, further comprising using a fill shoe to fill the apertures of the dispensing plate with the powder while the dispensing plate is laterally moved between the pressing position and the dispensing position.

13. The method of claim 11, wherein:
each of the apertures has an upper opening formed on a top surface of the dispensing plate and a lower opening formed on a bottom surface of the dispensing plate; and
the apertures are tapered such that the lower opening of each aperture is larger than its corresponding upper opening.

14. The method of claim 11, wherein the apertures comprise large apertures and small apertures, each of the large apertures having a volume that is at least 10% larger than a volume of each of the small apertures.

15. The method of claim 11, wherein the apertures disposed in a first region of the dispensing plate have a larger volume than the apertures disposed in a second region of the dispensing plate.

16. The method of claim 11, wherein a density of the apertures in a first region of the dispensing plate is higher than a density of the apertures in a second region of the dispensing plate.

17. The method of claim 11, wherein:
the article comprises an interconnect for an electrochemical cell stack; and
the interconnect comprises first ribs separated by first channels on a first side, and second ribs separated by second channels on a second side opposite to the first side.

18. The method of claim 17, further comprising:
removing the interconnect from the die cavity; and
sintering the interconnect, wherein the powder comprises chromium and iron powder.

19. The method of claim 18, further comprising placing the interconnect into an electrochemical cell stack.

20. The method of claim 17, wherein:
the powder is thicker in a peripheral region of the die cavity than in an intermediate region of the die cavity and in a central region of the die cavity;
the powder is thicker in the central region of the die cavity than in the intermediate region of the die cavity;
a flow field region of the interconnect containing ribs separated by channels is formed in the central region of the die cavity;
a peripheral frame seal region of the interconnect is formed in the peripheral region of the die cavity;
manifold regions of the interconnect are formed in the intermediate region of the die cavity; and
the manifold regions of the interconnect are thinner than the peripheral frame seal region of the interconnect.

21. The method of claim 11, wherein a lower punch is not raised into the die cavity between the step of laterally moving the dispensing plate and the base plate to the pressing position from the dispensing position and the step of pressing the powder in the die cavity to form the article.
